(19) United States
(12) Patent Application Publication
(10) Pub. No.: US 2025/0377560 A1
(43) Pub. Date: Dec. 11, 2025

(54) OPTICAL MODULATORS FOR PHOTONICS DEVICES AND METHODS THEREFOR

(71) Applicant: Taiwan Semiconductor Manufacturing Company, LTD., Hsinchu (TW)

(72) Inventors: Chia-Wei Chiang, Hsinchu (TW); Yi Min Wang, Hsinchu (TW); Sheng Kai Yeh, Taichung (TW); Chi-Yuan Shih, Zhubei (TW); Chun-Pei Wu, Mingjian (TW); Tse-En Chang, Hsinchu (TW); Shih-Fen Huang, Jhubei (TW)

(21) Appl. No.: 18/739,603

(22) Filed: Jun. 11, 2024

(51) Int. Cl. G02F 1/025; G02F 1/015; G02F 1/21

(52) U.S. Cl. CPC G02F 1/025; G02F 1/0152; G02F 1/212

(57) ABSTRACT

An optical modulator and methods of making and using the optical modulator are disclosed herein. The optical modulator includes a set of at least four vertically alternating negatively doped and positively doped interlocking fingers that form a P-N junction diode. The junction has a serpentine or sinusoidal shape which increases the junction surface area present within the same volume. The resulting modulation efficiency is increased significantly. The method for making the P-N junction includes self-alignment of the various components.

### BACKGROUND

Silicon photonics has quickly become a mainstream technology, particularly in photonic integrated circuits (PICs). Such circuits may be based on a silicon-on-insulator (SOI) platform to achieve high speed optical communication between integrated circuits and/or semiconductor dies.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a cross-sectional view of a first embodiment of an optical modulator, in accordance with some embodiments of the present disclosure.

FIG. 1B is a magnified cross-sectional view of the P-N junction diode of FIG. 1A.

FIG. 2 is a cross-sectional view of a second embodiment of an optical modulator, in accordance with some embodiments of the present disclosure. In this embodiment, a silicon-on-insulator (SOI) structure is used.

FIG. 3A and FIG. 3B together form a flow chart illustrating a method for making an optical modulator, in accordance with some embodiments.

FIG. 4 is a side cross-sectional view showing a base layer after trenches have been etched and a hard mask layer has been applied.

FIG. 5 is a side cross-sectional view showing the base layer after a first dopant type is implanted in the first trench and a first side of the waveguide region.

FIG. 6 is a side cross-sectional view showing the base layer after a second dopant type is implanted in the second trench and a second side of the waveguide region.

FIG. 7 is a side cross-sectional view showing the base layer after the second dopant concentration in the second trench is increased to form a second pickup channel.

FIG. 8 is a side cross-sectional view showing the base layer after the first dopant concentration in the first trench is increased to form a first pickup channel.

FIG. 9 is a side cross-sectional view showing the base layer after the two trenches are filled with a dielectric material.

FIG. 10 is a side cross-sectional view showing the base layer after a first doped region is implanted in the waveguide region.

FIG. 11 is a side cross-sectional view showing the base layer after a second doped region is implanted in the waveguide region.

FIG. 12 is a side cross-sectional view showing the base layer after a third doped region is implanted in the waveguide region.

FIG. 13 is a side cross-sectional view showing the base layer after a fourth doped region is implanted in the waveguide region.

FIG. 14 is a side cross-sectional view showing the base layer after thermal annealing is performed to form negatively-doped and positively-doped interlocking fingers in the waveguide region.

FIG. 15 is a side cross-sectional view showing the base layer after a first ohmic contact to the first pickup channel is formed on the upper surface of the base layer.

FIG. 16 is a side cross-sectional view showing the base layer after a second ohmic contact to the second pickup channel is formed on the upper surface of the base layer.

FIG. 17 is a plan view of a first embodiment of the optical modulator. Here, the optical modular is a micro-ring modulator (MRM) having a circular or ring shape.

FIG. 18 is a plan view of a second embodiment of the optical modulator. Here, the optical modular is a micro-ring modulator (MRM) having a racetrack shape.

FIG. 19 is a plan view of a third embodiment of the optical modulator. Here, the optical modular is a Mach-Zehnder modulator (MZM).

FIG. 20 is a plan view of a system having three optical modulators. The input optical signal to the system includes three different wavelengths. Each optical modulator selectively modulates the amplitude of one wavelength.

FIG. 21 is a flow chart illustrating a method for using an optical modulator, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

The present disclosure refers to temperatures for certain process steps. It is noted that these generally refer to the temperature at which the heat source (e.g. furnace) is set, and do not necessarily refer to the temperature which must be attained by the material being exposed to the heat.

The term “parallel” is used herein generally to describe two structures oriented in the same direction. This term should not be interpreted in a strict mathematical way requiring the two structures to never intersect with each other.

The present disclosure relates to structures which are made up of different layers. When the terms “on” or “upon” are used with reference to two different layers (including the substrate), they indicate merely that one layer is on or upon the other layer. These terms do not require the two layers to directly contact each other, and permit other layers to be between the two layers. For example all layers of the structure can be considered to be “on” the substrate, even though they do not all directly contact the substrate. The term “directly” may be used to indicate two layers directly contact each other without any layers in between them. In addition, when referring to performing process steps to the substrate or upon the substrate, this should be construed as performing such steps to whatever layers may be present on the substrate as well, depending on the context.

The present disclosure relates to optical modulators which are useful in a photonic integrated circuit. In this regard, a waveguide is commonly formed from a core surrounded by a cladding, with the refractive index of the core being greater than the refractive index of the cladding. Data in the form of one or more optical signals (i.e. light having one or more wavelengths) travel through the core. The optical signals can be modulated in amplitude by optical modulators, which are formed within the waveguide as a P-N junction. Applying a bias voltage to the P-N junction changes the charge carrier density of the P-N junction (also known as the plasma dispersion effect), which changes the refractive index and phase shift. This changes the resonant wavelength of the optical signal, causing a change in the amplitude of the signal.

The optical modulation amplitude (OMA) depends on the shape of the P-N junction and the doping profile of the P-N junction. A higher dopant concentration can provide a sharper P-N junction and higher carrier concentration, but can also lead to heightened optical loss and lower the Q-factor. Elevated parasitic capacitance can also occur, which reduces the electrical bandwidth for high-speed modulation. In the present disclosure, a fork-or finger-type P-N junction is formed through self-aligning processes. This provides a higher junction surface area in the same volume. The modulation efficiency is also significantly increased when compared to typical planar P-N junctions at comparable optical loss.

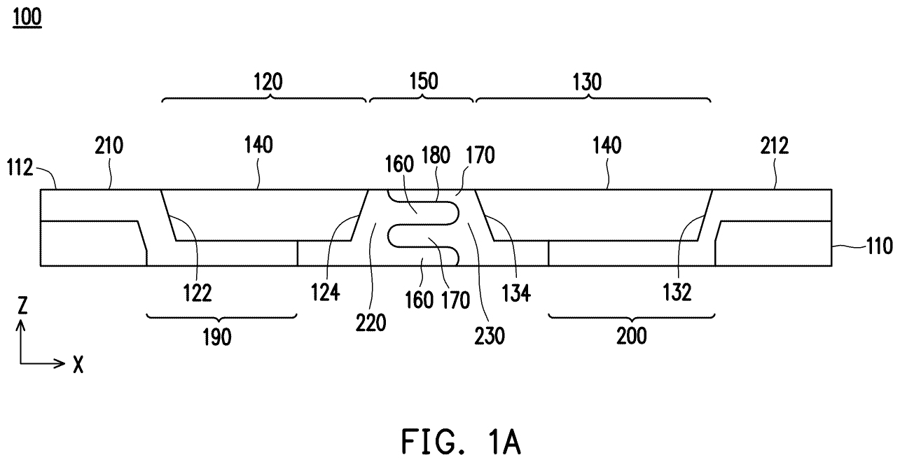

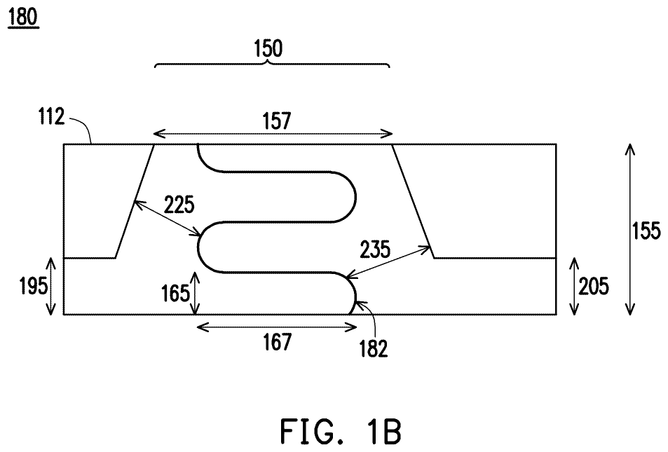

FIG. 1A is a cross-sectional view of a first embodiment of an optical modulator 100, in accordance with some embodiments of the present disclosure. FIG. 1B is a magnified cross-sectional view of the P-N junction diode 180.

Referring first to FIG. 1A, the optical modulator is made in a base layer 110. A first trench 120 and a second trench 130 were etched into the base layer, and those trenches are now filled with a dielectric material 140. A waveguide region 150 is present between the two trenches 120, 130. Each trench 120, 130 has a first sidewall 122, 132 which is not present in the waveguide region 150, and a second sidewall 124, 134 which is present in the waveguide region 150. A plurality of vertically alternating negatively doped and positively doped interlocking fingers is present in the waveguide region. As used here, the term “plurality” refers to the negatively doped fingers and the positively doped fingers individually, or in other words at least four total fingers are present. Two negatively doped fingers 160 and two positively doped fingers 170 are illustrated here, and form a P-N junction diode 180.

Continuing, then, a first pickup channel 190 is present in the first trench 120 and is electrically connected to a first ohmic contact 210 on an upper surface 112 of the base layer. The first pickup channel is located upon/within the first sidewall of the first trench and the floor of the first trench. The first pickup channel is formed by implanting a first dopant type. A second pickup channel 200 is present in the second trench 130 and is electrically connected to a second ohmic contact 212 on an upper surface 112 of the base layer. The second pickup channel is located upon/within the first sidewall of the second trench and the floor of the second trench. The second pickup channel is formed by implanting a second dopant type. The first dopant type and the second dopant type are different from each other in their charge. Put another way, one pickup channel (190 or 200) is negatively doped, and forms an electrical connection between one of the contacts (210 or 212) and the negatively doped fingers 160 in the waveguide region. The other pickup channel (200 or 190) is positively doped, and forms an electrical connection between the other contact (212 or 210) and the positively doped fingers 170 in the waveguide region.

A first linkage region 220 is present on the second sidewall 124 of the first trench. As illustrated here, this first linkage region 220 electrically connects the negatively doped fingers 160 to the first pickup channel 190. Similarly, a second linkage region 230 is present on the second sidewall 134 of the second trench, which electrically connects the positively doped fingers 170 to the second pickup channel 200.

Referring now to FIG. 1B, in particular embodiments, the waveguide region 150 may have a height 155 of about 160 nanometers (nm) to about 300 nm. In particular embodiments, the waveguide region has a width 157 of about 200 nm to about 500 nm, as measured at the upper surface 112.

In some embodiments, the thickness 225, 235 of each linkage region on the side of the waveguide region may independently be from about 50 nm to about 100 nm. The thickness 195, 205 of each pickup channel in the trench may independently be from about 30 nm to about 200 nm. In various embodiments, the width 167 of each finger may independently be from about 150 nm to about 450 nm. Similarly, the height 165 of each finger may independently be from about 30 nm to about 100 nm. Other ranges and values are contemplated for each of these heights, widths, and thicknesses as being within the scope of the present disclosure.

As seen in FIG. 1B, the junction 182 or interface between the negatively doped fingers and the positively doped fingers has a serpentine or sinusoidal shape when viewed in cross-section. The junction or interface is made up of a series of horizontal segments joined together by vertical segments (illustrated as semicircles here). The junction has a surface area, and a higher number of horizontal segments and vertical segments through the same thickness or height 155 indicates a higher surface area.

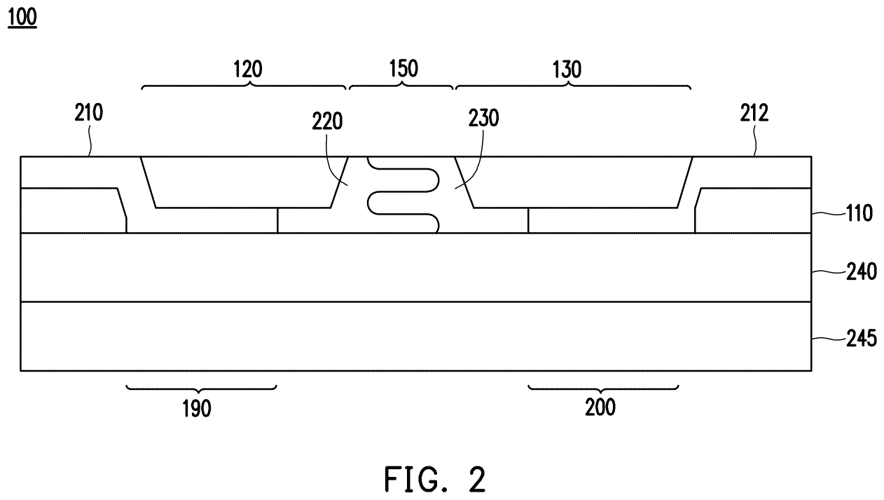

FIG. 2 is a cross-sectional view of a second embodiment of an optical modulator 100, in accordance with some embodiments of the present disclosure. In this embodiment, a silicon-on-insulator (SOI) structure is used. In this embodiment, a dielectric layer 240 is present below the base layer 110. A substrate 245 is present below the dielectric layer 240.

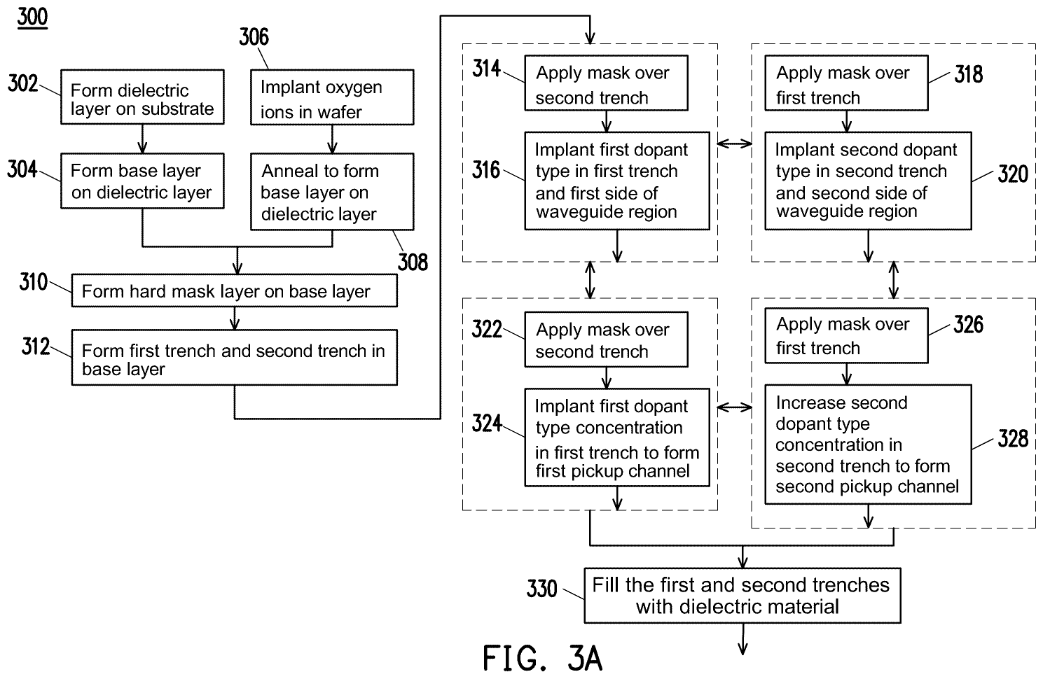

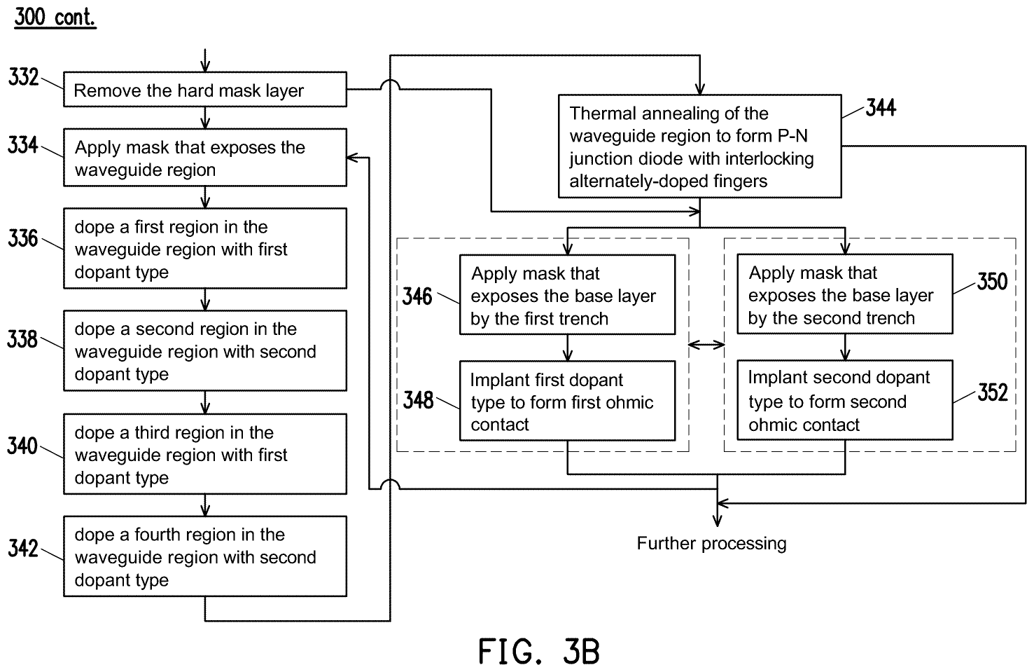

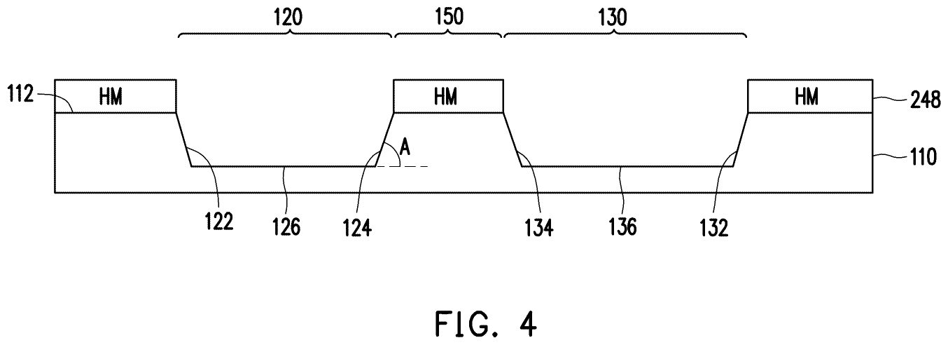

FIG. 3A and FIG. 3B together form a flow chart illustrating a method 300 for making an optical modulator, in accordance with some embodiments. Some steps of the method are also illustrated in FIGS. 4-16. The method steps are discussed below in terms of forming a single optical modulator, and should also be broadly construed as applying to the concurrent formation of multiple optical modulators. Additional steps may be performed between the various steps described herein, and some are omitted merely for clarity. Not all method steps may be needed to obtain the structures disclosed herein. Additionally, some of the method steps can be performed simultaneously, or in a different order than as shown or described here.

Initially, referring to FIG. 4, a base layer 110 is shown, which is made of a semiconducting material. Such semiconductor materials can include silicon, for example in the form of crystalline Si. In alternative embodiments, the substrate can be made of other elementary semiconductors such as germanium, or may include a compound semiconductor such as silicon carbide (SiC), gallium arsenide (GaAs), gallium carbide, gallium phosphide, indium arsenide (InAs), indium phosphide (InP), silicon germanium, silicon germanium carbide, gallium arsenic phosphide, or gallium indium phosphide. In particular embodiments, the base layer is made of silicon.

If it is desired to make the optical modulator 100 as illustrated in FIG. 1A, then the base layer is usually provided in the form of a wafer. However, if it is desired to use a silicon-on-insulator (SOI) structure as illustrated in FIG. 2, then a three-layer structure corresponding to the substrate 245, the dielectric layer 240, and the base layer 110 of FIG. 2 may be provided or constructed.

The three-layer structure may be made by deposition of two layers. In step 302 of FIG. 3A, a dielectric layer 240 is formed upon a substrate 245. This may be done, for example, by thermal oxidation, or by chemical vapor deposition (CVD), physical vapor deposition (PVD), atomic layer deposition (ALD), or other suitable methods. Then, in step 304 of FIG. 3A, a base layer 110 is formed upon the dielectric layer 240. This may be performed, for example, by CVD, PVD, or other suitable methods.

Alternatively, in step 306 of FIG. 3A, ion implantation is performed to deposit oxygen ions within a relatively thick wafer. Then, in step 308 of FIG. 3A, annealing is performed to obtain a dielectric layer 240 which separates the wafer into the substrate 245 and the base layer 110 shown in FIG. 2.

Next, in step 310 of FIG. 3A and as illustrated in FIG. 4, a hard mask layer 248 is formed over the upper surface 112 of the base layer 110 and patterned. The hard mask layer may generally be a dielectric material. Then, in step 312 of FIG. 3A, a first trench 120 and a second trench 130 are formed in the base layer 110. This is typically done by etching.

Referring to FIG. 4, a waveguide region 150 is present between the first trench 120 and the second trench 130. The first trench 120 has a floor 126, a first sidewall 122, and a second sidewall 124. The second trench 130 also has a floor 136, a first sidewall 132, and a second sidewall 134. The first sidewalls 122, 132 of the two trenches are opposite the waveguide region 150. The second sidewalls 124, 134 of the two trenches are present on each side of the waveguide region 150. A tilt angle A of the trench sidewalls is shown here relative to the floor and measured within the waveguide region. The tilt angle A may be, in some particular embodiments, from about 70° to about 120°, though other ranges are within the scope of the present disclosure.

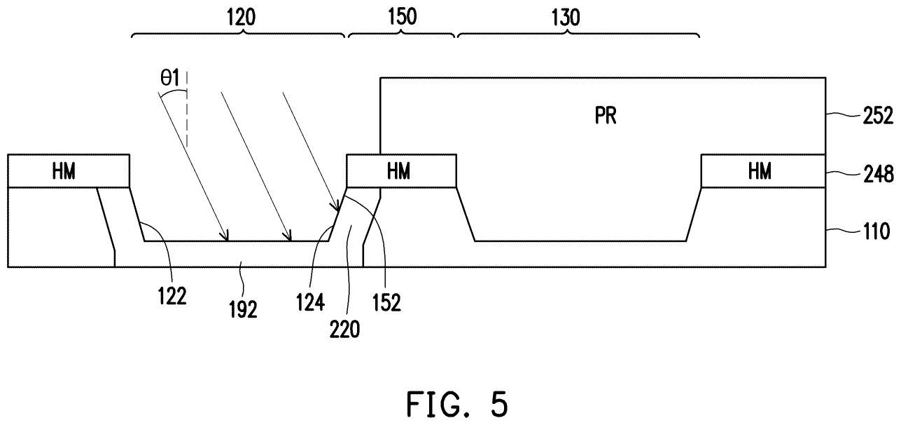

Continuing, in step 314 of FIG. 3A and as illustrated in FIG. 5, a first mask 252 is applied over the second trench 130. Both sidewalls 122, 124 and the floor of the first trench are exposed. Then, in step 316 of FIG. 3A, a first dopant type 192 is implanted in the first trench 120 and a first side 152 of the waveguide region. This may be performed by ion implantation. The first linkage region 220 is thus formed on a first side of the waveguide region 150.

Implantation of various ions into a silicon crystal lattice modifies the conductivity of the lattice in the implanted location, permitting the manufacture of the various parts of the optical modulator. An ion implanter generally includes an ion source, a beam line, and a process chamber. The ion source produces desired ions which act as dopants to change various properties in desired locations of the base layer. For example, positive and negative electrical contacts are formed using dopants that have a different polarity from the substrate. Common p-type dopants may include boron, gallium, or indium. Common n-type dopants may include phosphorus or arsenic. The resulting ion beam enters the beam line, which organizes the ions into a beam having high purity in terms of ion mass, energy, and species. The ion beam is then used to irradiate the base layer in the process chamber.

In some embodiments, the first dopant type is implanted at a dose from about 1×10¹³ to about 3×10¹⁵ cm⁻². In addition, the first dopant type may be implanted at an energy of about 20 keV to about 80 keV. The first dopant type may be implanted at an implant angle Θ1 of 0° to about 45° with respect to the vertical direction. Other ranges for each of these settings fall within the scope of this disclosure.

In some particular embodiments, the first dopant type is implanted in two separate implantation steps. In the first implantation step, the dopant type is implanted at a dose from about 1×10¹⁴ to about 6×10¹⁴ cm⁻², and at an energy of about 40 keV to about 80 keV. In the second implantation step, the dopant type is implanted at a dose from about 5×10¹³ to about 5×10¹⁴ cm⁻², and at an energy of about 20 keV to about 60 keV.

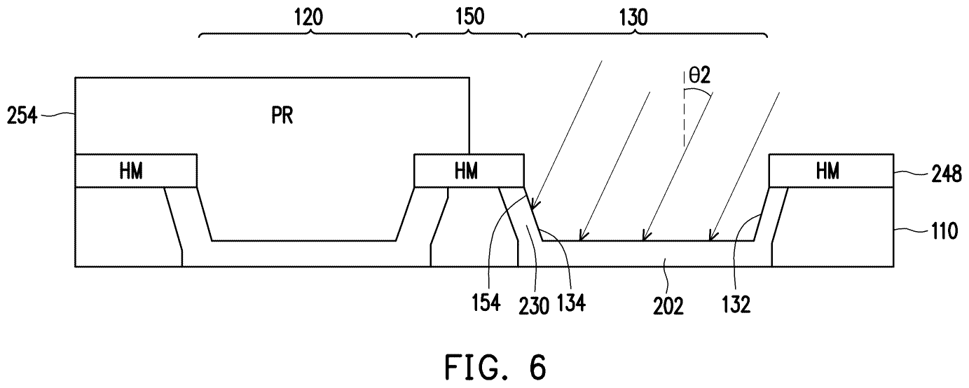

The first mask is then removed. Continuing, in step 318 of FIG. 3A and as illustrated in FIG. 6, a second mask 254 is applied over the first trench 120. Both sidewalls 132, 134 and the floor of the second trench are exposed. Then, in step 320 of FIG. 3A, a second dopant type 202 is implanted in the second trench 130 and a second side 154 of the waveguide region. This may also be performed by ion implantation. The second linkage region 230 is thus formed on a second side of the waveguide region 150.

In some embodiments, the second dopant type is implanted at a dose from about 1×10¹⁴ to about 3×10¹⁵ cm⁻². In addition, the second dopant type may be implanted at an energy of about 10 keV to about 30 keV. The second dopant type may be implanted at an implant angle Θ2 of 0° to about 45° with respect to the vertical direction. Other ranges for each of these settings fall within the scope of this disclosure.

The first dopant type and the second dopant type are different from each other. If the first dopant type is an n-type dopant, then the second dopant type is a p-type dopant, or vice versa. As illustrated here, the first dopant type is n-type, and the second dopant type is p-type. In this regard, the implantation depths for the two dopant types are designed to be the same. However, their energy levels will depend on their size and atomic weight, and thus may vary.

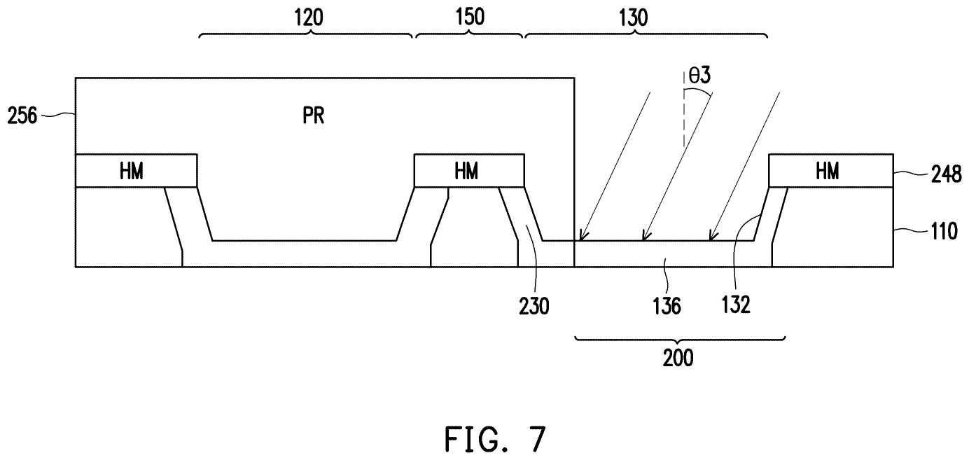

The second mask is then removed. Continuing, in step 322 of FIG. 3A and as illustrated in FIG. 7, a third mask 256 is applied over the first trench 120. The second sidewall of the second trench (also known as the second linkage region 230) is also covered by the mask. The floor 136 and the first sidewall 132 of the second trench are still exposed. Then, in step 324 of FIG. 3A, the second dopant type concentration in the second trench is increased to form a second pickup channel 200. This may also be performed by ion implantation. In some particular embodiments, the dopant concentration in the second pickup channel may be from about 2 to about 10 times higher than the dopant concentration in the second linkage region 230.

In some embodiments, the second dopant type is implanted at a dose from about 1×10¹⁴ to about 3×10¹⁵ cm⁻². In addition, the second dopant type may be implanted at an energy of about 10 keV to about 30 keV. The second dopant type may be implanted at an implant angle Θ3 of 0° to about 30° with respect to the vertical direction. Other ranges for each of these settings fall within the scope of this disclosure.

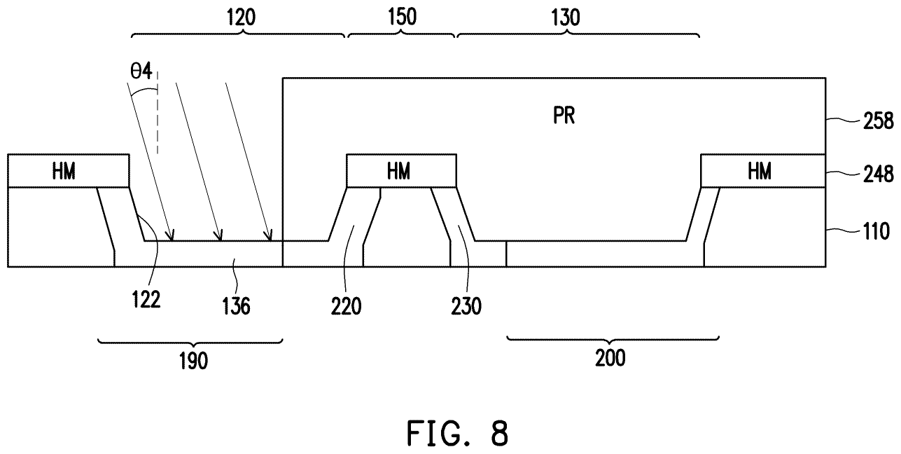

The third mask is then removed. Continuing, in step 326 of FIG. 3A and as illustrated in FIG. 8, a fourth mask 258 is applied over the second trench 130. The second sidewall of the first trench (also known as the first linkage region 220) is also covered by the mask. The floor 126 and the first sidewall 122 of the first trench are still exposed. Then, in step 328 of FIG. 3A, the first dopant type concentration in the first trench is increased to form a first pickup channel 190. This may also be performed by ion implantation. In some particular embodiments, the dopant concentration in the first pickup channel may be from about 2 to about 10 times higher than the dopant concentration in the first linkage region 220.

In some embodiments, the first dopant type is implanted at a dose from about 1×10¹⁴ to about 3×10¹⁵ cm⁻². In addition, the first dopant type may be implanted at an energy of about 10 keV to about 30 keV. The second dopant type may be implanted at an implant angle Θ4 of 0° to about 30° with respect to the vertical direction. Other ranges for each of these settings fall within the scope of this disclosure.

It is noted that the various steps 314-328 to form the first pickup channel 190 and the second pickup channel 200 may be performed in any order. This is indicated in FIG. 3A by the use of boxes surrounding each pair of steps where a mask is formed and ion implantation is performed.

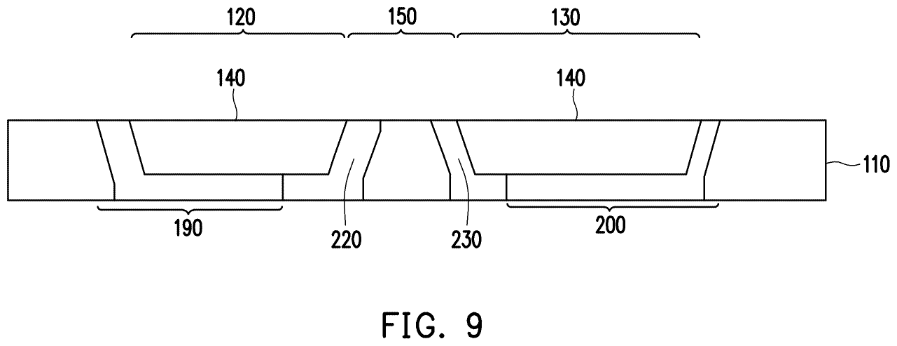

Next, in step 330 of FIG. 3A and as illustrated in FIG. 9, the first trench 120 and the second trench 130 are filled with a dielectric material. The trenches may be filled by deposition, for example CVD, PVD, or other suitable material. Then, in step 332 of FIG. 3B, the hard mask layer is removed. This may be done using a chemical mechanical polishing (CMP) process. It is noted that these two steps may be performed in either order. However, it may be preferable to fill the trenches first and then perform the CMP step, because this ensures a planar surface in the trenches without the need to perform a second CMP step in the event of excess deposition of the dielectric material.

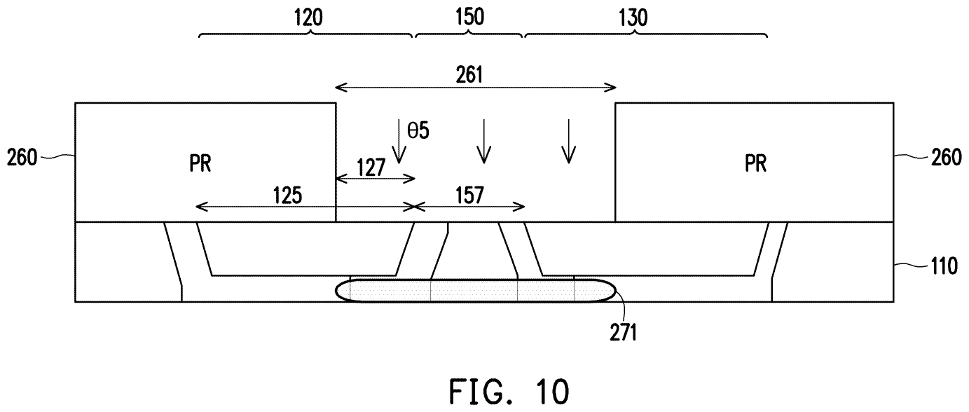

Next, in step 334 of FIG. 3B and as illustrated in FIG. 10, a fifth mask 260 is applied that covers the first trench and the second trench, and exposes the waveguide region 150. The opening over the waveguide region has a width 261 that is greater than the width 157 of the waveguide region. The width 261 can provide a margin of 0 nm to about 2000 nm with respect to the waveguide region, so that subsequent ion implantation steps can be performed with the resulting depositions aligned within the waveguide region. The first trench 120 has a width 125, and the margin between the width 261 of the opening and the width 157 of the waveguide region on either side is indicated with reference numeral 127. Generally, the width 125 is greater than the margin 127.

Continuing, in step 336 of FIG. 3B and as illustrated in FIG. 10, a first region 271 in the waveguide region is doped with the first dopant type. This may be performed using ion implantation through the opening in the fifth mask 260. In particular embodiments, the first dopant type is implanted at a dose from about 5×10¹³ to about 5×10¹⁴ cm⁻². In addition, the first dopant type may be implanted at an energy of about 100 keV to about 200 keV. The implant angle Θ5 for this implantation step is generally 0° with respect to the vertical direction. Other ranges for each of these settings fall within the scope of this disclosure.

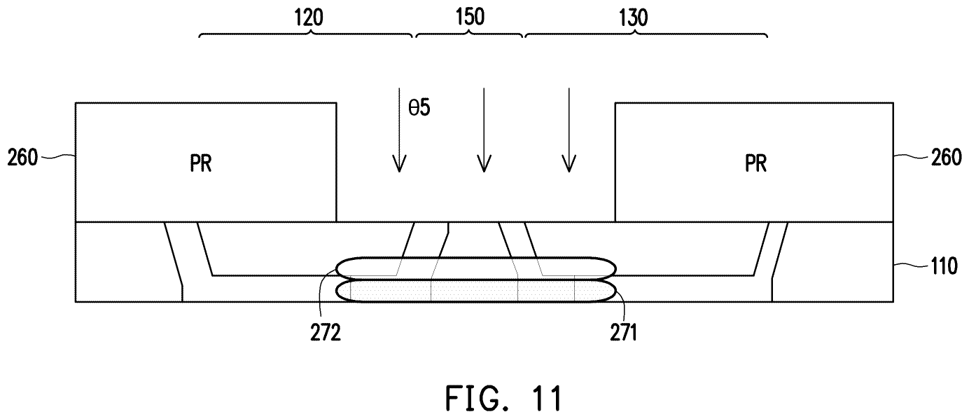

Then, in step 338 of FIG. 3B and as illustrated in FIG. 11, a second region 272 in the waveguide region is doped with the second dopant type. This may be performed using ion implantation through the opening in the fifth mask 260. In particular embodiments, the second dopant type is implanted at a dose from about 5×10¹³ to about 5×10¹⁴ cm⁻². In addition, the second dopant type may be implanted at an energy of about 20 keV to about 60 keV. The implant angle Θ5 for this implantation step is generally 0° with respect to the vertical direction. Other ranges for each of these settings fall within the scope of this disclosure. The second region 272 is located above the first region 271.

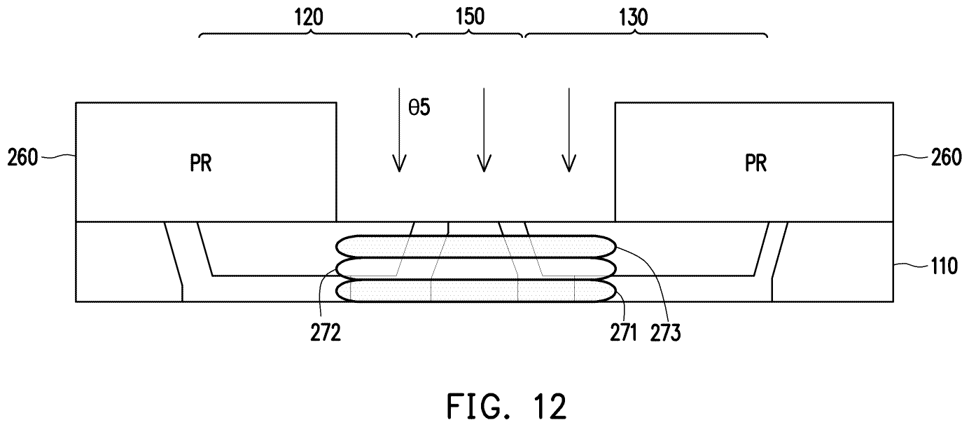

Next, in step 340 of FIG. 3B and as illustrated in FIG. 12, a third region 273 in the waveguide region is doped with the first dopant type. This may be performed using ion implantation through the opening in the fifth mask 260. In particular embodiments, the first dopant type is implanted at a dose from about 5×10¹³ to about 5×10¹⁴ cm⁻². In addition, the first dopant type may be implanted at an energy of about 20 keV to about 50 keV. The implant angle Θ5 for this implantation step is generally 0° with respect to the vertical direction. Other ranges for each of these settings fall within the scope of this disclosure. The third region 273 is located above the second region 272.

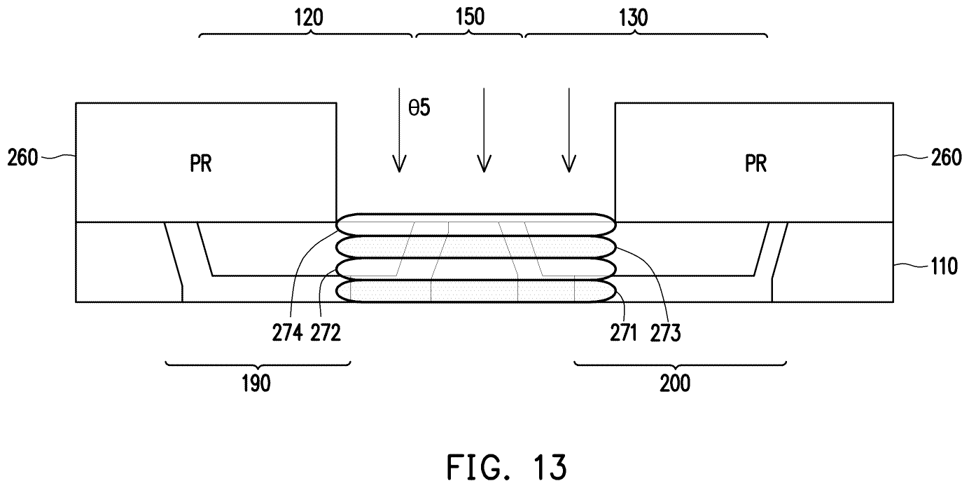

Finally, in step 342 of FIG. 3B and as illustrated in FIG. 13, a fourth region 274 in the waveguide region is doped with the second dopant type. This may be performed using ion implantation through the opening in the fifth mask 260. In particular embodiments, the second dopant type is implanted at a dose from about 5×10¹³ to about 5×10¹⁴ cm⁻². In addition, the second dopant type may be implanted at an energy of greater than 0 keV to about 30 keV. The implant angle Θ5 for this implantation step is generally 0° with respect to the vertical direction. Other ranges for each of these settings fall within the scope of this disclosure. The fourth region 274 is located above the third region 272. Generally, then, the implantation energy gradually decreases from the first region to the fourth region.

Generally, then, a plurality of first dopant regions and a plurality of second dopant regions are formed in the waveguide region. The regions alternate in a vertical direction. These dopant regions will become the interlocking fingers 260, 270 of FIG. 1B. Put another way, the first region 271 and the third region 273 are doped with one dopant type (p-type or n-type), and the second region 272 and the fourth region 274 are doped with the other dopant type (n-type or p-type, respectively). The number of interlocking fingers is not limited to only four total fingers, and may vary depending on the thickness 155 of the waveguide region. In some particular embodiments, the number of first dopant regions and the number of second dopant regions may independently be from two to five (2 to 5). It is noted that generally, the number of first dopant regions and the number of second dopant regions will differ at most by one (1).

Continuing, it is noted that the dopant concentration in the first linkage region 220 and the second linkage region 230 is higher than the dopant concentration in the four regions 271, 272, 273, 274. For example, then, the portion of the second region (containing the second dopant type) that overlaps the first linkage region (containing the first dopant type) is counter-doped and the first linkage region maintains its first dopant type. Similarly, the dopant concentration in the first pickup channel 190 and the second pickup channel 200 is higher than the dopant concentration in the four regions 271, 272, 273, 274.

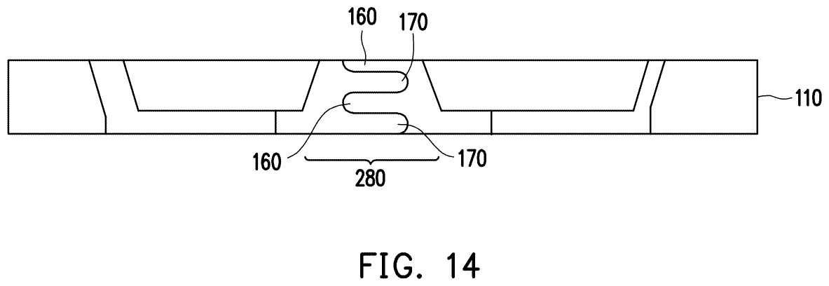

After the fifth mask 260 is removed, then in step 344 of FIG. 3B and as illustrated in FIG. 14, thermal annealing of the waveguide region is performed. In some embodiments, the thermal annealing is performed at a temperature from about 900° C. to about 1100° C. The thermal annealing may be performed for a time of about 10 seconds to about 100 minutes. Other temperature and time ranges are also within the scope of this disclosure. As a result, a P-N junction diode 180 is formed from interlocking negatively doped fingers 160 and positively doped fingers 170.

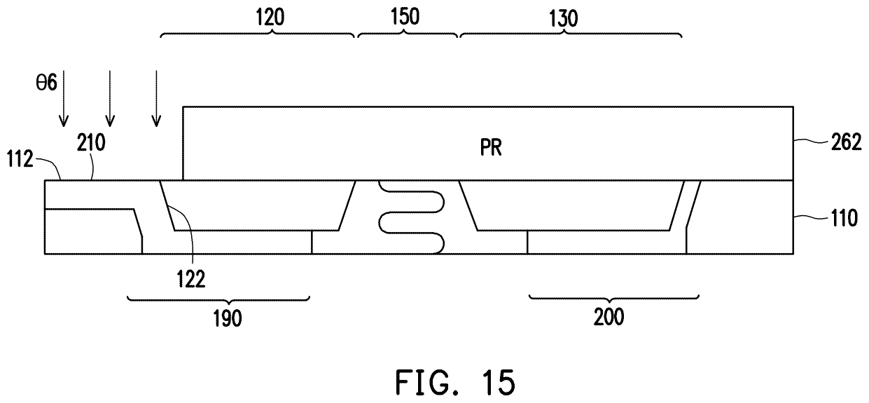

Continuing, in step 346 of FIG. 3B and as illustrated in FIG. 15, a sixth mask 262 is applied that covers the second pickup channel 200 and the waveguide region 150, and exposes the first sidewall 122 of the first trench 120. Then, in step 348 of FIG. 3B, ion implantation of the first dopant type is performed in the upper surface 112 of the base layer to form a first ohmic contact 210 to the first pickup channel 190.

In some embodiments, the first dopant type is implanted at a dose from about 1×10¹⁴ to about 3×10¹⁵ cm⁻². In addition, the first dopant type may be implanted at an energy of about 5 keV to about 30 keV. The first dopant type may be implanted at an implant angle Θ6 of 0° to about 30° with respect to the vertical direction. Other ranges for each of these settings fall within the scope of this disclosure.

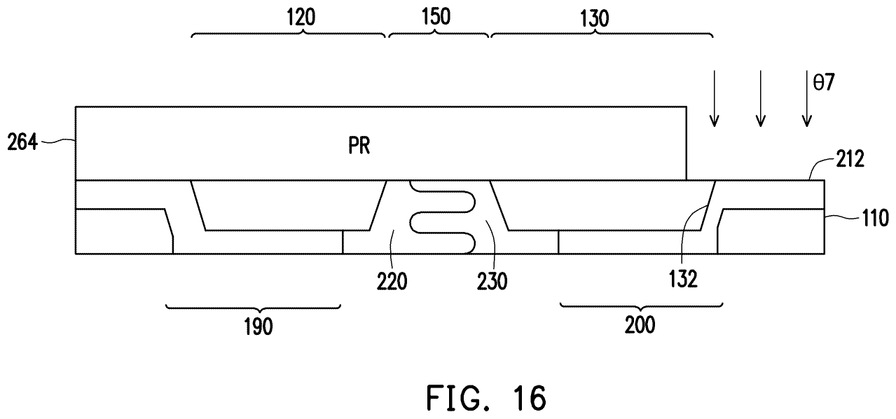

After the sixth mask 262 is removed, then in step 350 of FIG. 3B and as illustrated in FIG. 16, a seventh mask 264 is applied that covers the first pickup channel 190 and the waveguide region 150, and exposes the first sidewall 132 of the second trench 130. Then, in step 352 of FIG. 3B, ion implantation of the second dopant type is performed in the upper surface of the base layer to form a second ohmic contact 212 to the second pickup channel 200.

In some embodiments, the second dopant type is implanted at a dose from about 1×10¹⁴ to about 3×10¹⁵ cm⁻². In addition, the second dopant type may be implanted at an energy of about 5 keV to about 30 keV. The second dopant type may be implanted at an implant angle Θ7 of 0° to about 30° with respect to the vertical direction. Other ranges for each of these settings fall within the scope of this disclosure.

It is noted that the formation of the first ohmic contact 210 and the second ohmic contact 212 may be done in any order. This is indicated in FIG. 3B by the use of boxes surrounding each pair of steps where a mask is formed and ion implantation is performed. In addition, it is contemplated that the two ohmic contacts 210, 212 could be formed after third mask layer is removed and before the waveguide region 150 is doped. This is indicated with arrows running from step 332 to steps 346-352, and then back to step 334. The thermal annealing step 344 would then be the final step to form the optical modulator.

As a result, one electrically conductive path is present from the first ohmic contact 210 through the first pickup channel 190 to the first linkage region 220 and the fingers 160 electrically connected thereto. A second electrically conductive path is also present from the second ohmic contact 212 through the second pickup channel 200 to the second linkage region 230 and the fingers 170 electrically connected thereto. The resulting optical modulator 100 is shown in FIG. 1A. Further processing steps or operations may occur to build the final semiconductor device.

For clarity, it is noted that the first ohmic contact and the first pickup channel can be negatively doped and linked to the negatively doped fingers, and the second ohmic contact and the second pickup channel can be positively doped and linked to the positively doped fingers. Alternatively, the first ohmic contact and the first pickup channel can be positively doped and linked to the positively doped fingers, and the second ohmic contact and the second pickup channel can be negatively doped and linked to the negatively doped fingers.

The structures and methods of the present disclosure discussed above refer to dielectric layers. Such dielectric layers can generally be made from any suitable dielectric material or combination thereof, although the characteristics of any particular layer may also be further defined. Examples of dielectric materials may include silicon dioxide (SiO₂), silicon nitride (Si₃N₄), silicon carbide (SiC), hafnium dioxide (HfO₂), zirconium dioxide (ZrO₂), aluminum oxide (Al₂O₃), silicon oxynitride (SiOₓN_{y}), hafnium oxynitride (HfOₓN_{y}) or zirconium oxynitride (ZrOₓN_{y}), or hafnium silicates (HfSiₓO_{y}) or zirconium silicates (ZrSiₓO_{y}) or silicon carboxynitride (SiCₓO_{y}N_{z}), or hexagonal boron nitride (hBN). Other dielectric materials may include tantalum oxide (Ta₂O₅), nitrides such as silicon nitride, polysilicon, phosphosilicate glass (PSG), fluorosilicate glass (FSG), undoped silicate glass (USG), high-stress undoped silicate glass (HSUSG), and borosilicate glass (BSG). The dielectric layer may be formed by any suitable means, including chemical vapor deposition (CVD), physical vapor deposition (PVD), atomic layer deposition (ALD), thermal oxidation, or other suitable methods.

It is also noted that certain conventional steps are not expressly described in the discussion above. For example, a pattern/structure may be formed in a given layer by applying a photoresist layer, patterning the photoresist layer, developing the photoresist layer to form a mask, and then etching through the mask to transfer the pattern to the given layer.

Generally, a photoresist layer may be applied, for example, by spin coating, or by spraying, roller coating, dip coating, or extrusion coating. Typically, in spin coating, the substrate is placed on a rotating platen, which may include a vacuum chuck that holds the substrate in plate. The photoresist composition is then applied to the center of the substrate. The speed of the rotating platen is then increased to spread the photoresist evenly from the center of the substrate to the perimeter of the substrate. The rotating speed of the platen is then fixed, which can control the thickness of the final photoresist layer.

Next, the photoresist composition is baked or cured to remove the solvent and harden the photoresist layer. In some particular embodiments, the baking occurs at a temperature of about 90° C. to about 110° C. The baking can be performed using a hot plate or oven, or similar equipment. As a result, the photoresist layer is formed on the substrate.

The photoresist layer is then patterned via exposure to radiation. The radiation may be any light wavelength which carries a desired mask pattern. In particular embodiments, EUV light having a wavelength of about 13.5 nm is used for patterning, as this permits smaller feature sizes to be obtained. This results in some portions of the photoresist layer being exposed to radiation, and some portions of the photoresist not being exposed to radiation. This exposure causes some portions of the photoresist to become soluble in the developer and other portions of the photoresist to remain insoluble in the developer.

An additional photoresist bake step (post exposure bake, or PEB) may occur after the exposure to radiation. For example, this may help in releasing acid leaving groups (ALGs) or other molecules that are significant in chemical amplification photoresist.

The photoresist layer is then developed using a developer. The developer may be an aqueous solution or an organic solution. The soluble portions of the photoresist layer are dissolved and washed away during the development step, leaving behind a photoresist pattern (i.e. a mask). One example of a common developer is aqueous tetramethylammonium hydroxide (TMAH). Generally, any suitable developer may be used. Sometimes, a post develop bake or “hard bake” may be performed to stabilize the photoresist pattern after development, for optimum performance in subsequent steps.

Continuing, portions of the given layer below the patterned photoresist mask are now exposed. Etching transfers the photoresist pattern to the given layer below the patterned photoresist mask. After use, the mask can be removed, for example, using various solvents such as N-methyl-pyrrolidone (NMP) or alkaline media or other strippers at elevated temperatures, or by dry etching using oxygen plasma.

Generally, any etching step described herein may be performed using wet etching, dry etching, or plasma etching processes such as reactive ion etching (RIE) or inductively coupled plasma (ICP), or combinations thereof, as appropriate. The etching may be anisotropic. Depending on the material, etchants may include carbon tetrafluoride (CF₄), hexafluoroethane (C₂F₆), octafluoropropane (C₃F₈), fluoroform (CHF₃), difluoromethane (CH₂F₂), fluoromethane (CH₃F), carbon fluorides, nitrogen (N₂), hydrogen (H₂), oxygen (O₂), argon (Ar), xenon (Xe), xenon difluoride (XeF₂), helium (He), carbon monoxide (CO), carbon dioxide (CO₂), fluorine (F₂), chlorine (Cl₂), hydrogen bromide (HBr), hydrofluoric acid (HF), nitrogen trifluoride (NF₃), sulfur hexafluoride (SF₆), boron trichloride (BCl₃), ammonia (NH₃), bromine (Br₂), or the like, or combinations thereof in various ratios. For example, silicon dioxide can be wet etched using hydrofluoric acid and ammonium fluoride. Alternatively, silicon dioxide can be dry etched using various mixtures of CHF₃, O₂, CF₄, and/or H₂.

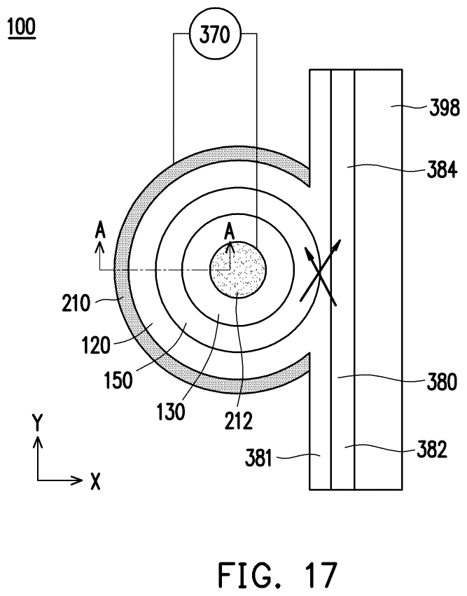

In some embodiments, the optical modulator 100 is a micro-ring modulator (MRM). FIG. 17 is a plan view of one embodiment of an MRM, where the optical modulator 100 has the shape of a circle when viewed from above. Line A-A indicates a cross-sectional view corresponding to that of FIG. 1A or FIG. 2. The first ohmic contact 210, the first trench 120 filled with dielectric material, the waveguide region 150, the second trench 130 filled with dielectric material, and the second ohmic contact 212 are seen here having concentric annular or circular shapes.

A bias voltage 370 can be applied across the two ohmic contacts 210, 212 to modulate the optical signal. A linear waveguide 380 is optically coupled to the optical modulator 100, but physically separated therefrom by a dielectric layer. The linear waveguide acts as an input 382 for an optical signal to travel into the waveguide region 150 of the optical modulator, and also acts as an output 384 that receives the modulated optical signal from the waveguide region of the optical modulator and carries the modulated optical signal downstream for further processing. The linear waveguide 380 is bounded by two dielectric regions 381, 398.

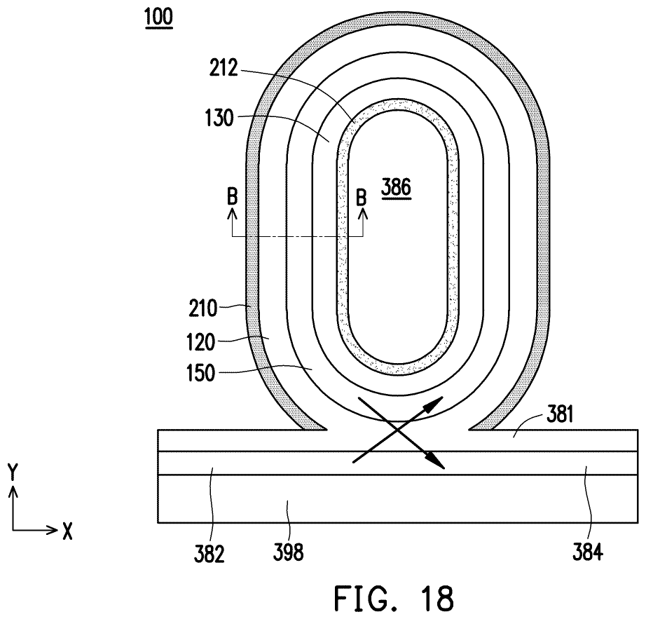

FIG. 18 is a plan view of another embodiment of an MRM, where the optical modulator 100 has the shape of a racetrack when viewed from above. The racetrack shape includes two parallel segments joined together at their ends by semicircular segments. Line B-B indicates a cross-sectional view corresponding to that of FIG. 1A or FIG. 2. The first ohmic contact 210, the first trench 120 filled with dielectric material, the waveguide region 150, the second trench 130 filled with dielectric material, and the second ohmic contact 212 all have a racetrack shape. A dielectric region 386 is surrounded by the second ohmic contact 212. An input 382 and an output 384 are also coupled to the waveguide region 150. Alternatively, the dielectric region 386 is not present, and the second ohmic contact 212 fills the space illustrated in this figure.

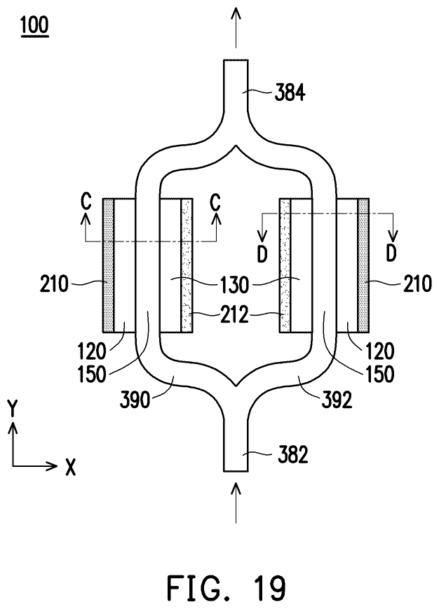

In some embodiments, the optical modulator 100 is a Mach-Zehnder modulator (MZM). FIG. 19 is a plan view of one embodiment of an MZM. In an MZM, an incoming optical signal from input 382 is split into two paths 390, 392. Each path includes a first ohmic contact 210, a first trench 120 filled with dielectric material, a waveguide region 150, a second trench 130 filled with dielectric material, and a second ohmic contact 212. Line C-C and line D-D each indicate a cross-sectional view corresponding to that of FIG. 1A or FIG. 2. Each path can be phase shifted, and the paths are then recombined. Constructive or destructive interference between the two paths 390, 392 causes a modulated optical signal to be transmitted through the output 384.

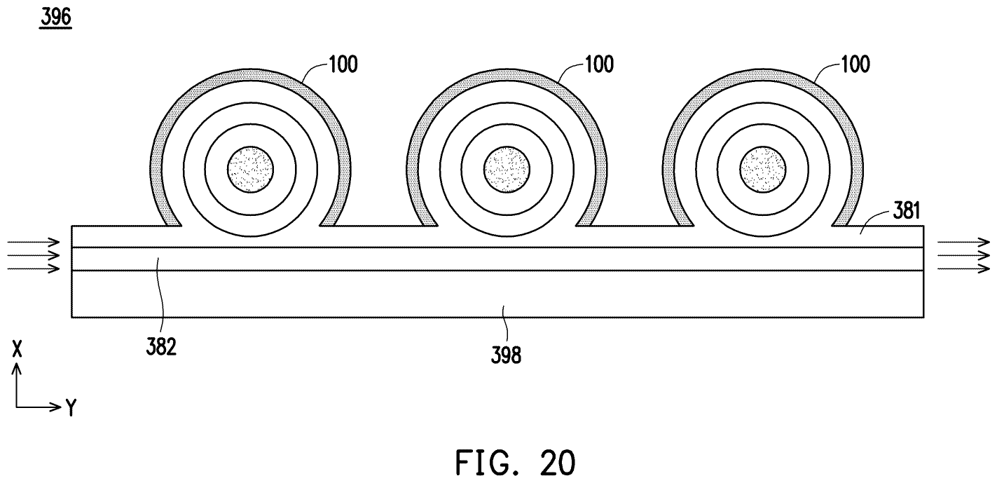

Wavelength division multiplexing may be used to transmit multiple optical signals (each having a different wavelength) through a single waveguide to increase the signal density. Such optical signals may be produced by lasers of different wavelengths. Each optical signal may use its own optical modulator for amplitude modulation. FIG. 20 is a plan view of one example of such a system 396. In this example, the input 382 to the system carries three different optical signals (i.e. three different wavelengths). Thus, the linear waveguide 380 is coupled to three optical modulators 100. Each optical modulator selectively modulates the amplitude of one wavelength.

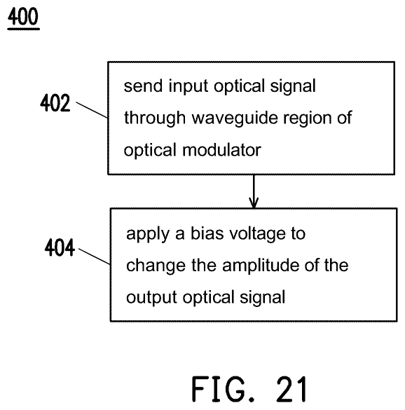

FIG. 21 is a flow chart illustrating a method 400 for using an optical modulator, in accordance with some embodiments. The method steps are discussed below in terms of a single optical modulator, and should also be broadly construed as applying to multiple optical modulators.

In step 402 of FIG. 21, and referring to FIG. 17, an input optical signal 382 is sent through a waveguide region 150 of the optical modulator 100. The waveguide region contains a P-N junction diode 180 with a plurality of vertically alternating negatively doped and positively doped interlocking fingers 160, 170 as shown in FIG. 1B. The input optical signal may be, for example, a laser beam or another light source. The optical signal is coupled to the waveguide region 150 by its wavelength. If the wavelength of the optical signal is at the resonant wavelength, then the signal will be coupled strongly to the optical modulator. Otherwise, the input optical signal will continue along the linear waveguide 380. In step 404 of FIG. 21, a bias voltage is applied to the P-N junction diode to change the amplitude of the output optical signal 384. The bias voltage applied will depend on the desired change in the amplitude. The amplitude can be changed, for example, to create an output signal that carries information, or to maintain a constant output (for example if the input signal fluctuates), or to produce a pulsed signal.

The structures of the present disclosure have several advantages. The junction of the P-N diode formed by the interlocking-fingers provides a higher surface area in a limited space. The resulting modulation efficiency is very high. The manufacturing process is self-aligned, and the implant boundary is designed to be larger than the waveguide region to avoid variations that may result due to mask alignment or critical dimension. The junction profile is also established through thermal diffusion and implant energy/dose, rather than using a mask. This increases consistency and device yield.

Some embodiments of the present disclosure thus relate to methods for making an optical modulator. A hard mask layer is formed over an upper surface of a base layer; A first trench and a second trench are formed in the base layer to define a waveguide region between the first trench and the second trench. A first dopant type is implanted in the first trench and in a first side of the waveguide region. A second dopant type is implanted in the second trench and in a second side of the waveguide region. The first dopant type concentration in the first trench is increased to form a first pickup channel. The second dopant type concentration in the second trench is increased to form a second pickup channel. The first trench and the second trench are filled with a dielectric material, and the hard mask layer is removed. A plurality of vertically alternating negatively doped regions and positively doped regions is formed in the waveguide region. The waveguide region is annealed to form a P-N junction diode with a plurality of negatively doped and positively doped interlocking fingers. A first ohmic contact to the first pickup channel is formed on the upper surface of the base layer. A second ohmic contact to the second pickup channel is formed on the upper surface of the base layer. The optical modulator is thus obtained.

Other embodiments disclosed herein relate to an optical modulator. The modulator comprises a waveguide region which contains a P-N junction diode with a plurality of vertically alternating negatively doped and positively doped interlocking fingers. A negatively-doped pickup channel electrically connects a first ohmic contact to the negatively doped fingers. A positively-doped pickup channel electrically connects a second ohmic contact to the positively doped fingers.

Also described in various embodiments herein are methods of using an optical modulator. An input optical signal is sent through a waveguide region of the optical modulator. The waveguide region contains a P-N junction diode with a plurality of vertically alternating negatively doped and positively doped interlocking fingers. A bias voltage is applied to the P-N junction diode to change an amplitude of an output optical signal.

The present disclosure also relates in various embodiments to systems that include an input, an output, and at least one optical modulator coupled to the input and the output.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for making an optical modulator, comprising:
forming a hard mask layer over an upper surface of a base layer;
forming a first trench and a second trench in the base layer to define a waveguide region between the first trench and the second trench;
implanting a first dopant type in the first trench and in a first side of the waveguide region;
implanting a second dopant type in the second trench and in a second side of the waveguide region;
increasing a second dopant type concentration in the second trench to form a second pickup channel;
increasing a first dopant type concentration in the first trench to form a first pickup channel;
filling the first trench and the second trench with a dielectric material;
removing the hard mask layer;
forming a plurality of vertically alternating negatively doped regions and positively doped regions in the waveguide region;
annealing the waveguide region to form a P-N junction diode with a plurality of negatively doped and positively doped interlocking fingers;
forming a first ohmic contact to the first pickup channel on the upper surface of the base layer; and
forming a second ohmic contact to the second pickup channel on the upper surface of the base layer to obtain the optical modulator.

2. The method of claim 1, wherein the first trench and the second trench have sidewalls with a tilt angle of about 70° to about 120°.

3. The method of claim 1, wherein implanting of the first dopant type and the second dopant type occurs at an angle of 0° to about 45°.

4. The method of claim 1, wherein the first dopant type concentration in the first pickup channel and the second dopant type concentration in the second pickup channel is higher than a dopant concentration of the plurality of interlocking fingers.

5. The method of claim 1, wherein a first dopant concentration in the first side of the waveguide region and a second dopant concentration in the second side of the waveguide region is higher than a dopant concentration of the plurality of interlocking fingers.

6. The method of claim 1, wherein the waveguide region has a height of about 160 nm to about 300 nm.

7. The method of claim 1, wherein the waveguide region has a width of about 200 nm to about 500 nm.

8. The method of claim 1, wherein the annealing occurs at a temperature of about 900° C. to about 1100° C. for a time of about 10 seconds to about 100 minutes.

9. The method of claim 1, wherein the plurality of vertically alternating negatively doped regions and positively doped regions in the waveguide region comprises:
a first region with the first dopant type;
a second region with the second dopant type, wherein the second region is above the first region;
a third region with the first dopant type, wherein the third region is above the second region; and
a fourth region with the second dopant type, wherein the fourth region is above the third region.

10. The method of claim 1, wherein the optical modulator is a micro-ring modulator or a Mach-Zehnder modulator.

11. The method of claim 1, wherein the first dopant type is an n-type dopant, and the second dopant type is a p-type dopant.

12. The method of claim 1, wherein the optical modulator further comprises a dielectric layer below the base layer and a substrate below the dielectric layer.

13. An optical modulator, comprising:
a waveguide region containing a P-N junction diode with a plurality of vertically alternating negatively doped and positively doped interlocking fingers;
a negatively-doped pickup channel electrically connecting a first ohmic contact to the negatively doped fingers; and
a positively-doped pickup channel electrically connecting a second ohmic contact to the positively doped fingers.

14. The optical modulator of claim 12, wherein the optical modulator has the shape of a circle or a racetrack when viewed from above.

15. The optical modulator of claim 13, wherein a dopant concentration of the negatively-doped pickup channel is higher than a dopant concentration of the negatively-doped fingers, or wherein a dopant concentration of the positively-doped pickup channel is higher than a dopant concentration of the positively-doped fingers, by a factor of about 2 to about 10.

16. The optical modulator of claim 13, further comprising a first dielectric trench between the waveguide region and the first ohmic contact, and a second dielectric trench between the waveguide region and the second ohmic contact.

17. The optical modulator of claim 13, further comprising an input and an output coupled to the waveguide region.

18. The optical modulator of claim 13, wherein the waveguide region is formed in a base layer, and the optical modulator further comprises a dielectric layer below the base layer and a substrate below the dielectric layer.

19. A method of using an optical modulator, comprising:
sending an input optical signal through a waveguide region of the optical modulator, wherein the waveguide region contains a P-N junction diode with a plurality of vertically alternating negatively doped and positively doped interlocking fingers; and
applying a bias voltage to the P-N junction diode to change an amplitude of an output optical signal.

20. The method of claim 19, wherein the input optical signal includes a plurality of wavelengths, and an amplitude of only a single wavelength is changed by the optical modulator.
